(19) United States
(12) Patent Application Publication
(10) Pub. No.: US 2007/0130830 A1
(43) Pub. Date: Jun. 14, 2007

(54) Staged combustion for a fuel reformer

(76) Inventors: Balachandar Varatharajan, Clifton Park, NY (US); Venkat Eswarlu Tangirala, Niskayuna, NY (US); Joel Meier Haynes, Schenectady, NY (US); Anthony John Dean, Scotia, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/302,658

(22) Filed: Dec. 14, 2005

(51) Int. Cl. B01J 8/00

(52) U.S. Cl. 48/127.9; 518/702; 518/703; 422/191; 422/192; 422/195; 422/194; 422/198; 422/211

(57) ABSTRACT

A multi-stage combustion fuel reformer (20) wherein heat energy from a leaner-burning stage (22) is used to accelerate the fuel reforming kinetics of a richer-burning stage (28). The two stages may be axially arranged (36) or radially arranged (50) with respect to each other. Both stages (64, 66) may utilize gas-phase combustion; or both stages (78, 82) may utilized catalytic combustion; or both gas-phase ((90) and catalytic combustion (92) may be used together. The multi-stage reformer (112) may form part of a gas-to-liquid fuel reforming system (110).

### FIELD OF THE INVENTION

The present invention relates generally to the reforming of a combustible fuel, and more particularly to a combustion process for partially oxidizing a gaseous fuel to produce a synthesis gas rich in carbon monoxide and hydrogen.

### BACKGROUND OF THE INVENTION

Systems that manufacture liquid hydrocarbons from gases rich in carbon monoxide and hydrogen using a Fischer-Tropsch reactor are well known in the art. A fuel reforming process, such as a process that reforms natural gas into a synthesis gas containing carbon monoxide and hydrogen, may be used to produce the feed gas for the Fischer-Tropsch reactor.

Known fuel-reforming processes include plasma reforming, steam reforming, and combustion reforming. Plasma reforming has not yet developed into a commercially significant process. Steam reforming is commonly used, but has the disadvantage of consuming water that may not be readily available in certain locations. Combustion reforming systems are widely used to convert fuel from an available form (such as methane) to a more desirable form (such as carbon monoxide and hydrogen) by only partially combusting the fuel under controlled conditions. Such systems are typically operated in pure oxygen rather than air (approximately 21% oxygen).

Combustion fuel-reforming systems are operated at fuel-rich equivalence ratios so that a partial oxidation reaction is favored over an oxidation reaction. When methane is used as the fuel, fuel-rich combustion is used to favor the partial oxidation reaction of
CH₄+½O₂=CO+2H₂ (1)
over the oxidation reaction of
CH₄+2O₂=CO₂+2H₂O (2)
For premixed combustion at fuel-rich conditions (φ>1), the flame temperatures obtained (e.g. 1,250° K. at φ=4) are lower than in diffusion flame systems operating at near-stoichiometric flame temperatures (e.g. 3,600° K. at φ=1), and thus the kinetics of the oxidation process are slow. In order to reach equilibrium conditions with such slow kinetics, residence times of up to two seconds may be required, thus resulting in the need for physically large combustors. Furthermore, the stability of the flame may be problematic at such fuel-rich conditions.

Diffusion flame reformers may provide a more stable combustion process by combining fuel and oxygen at locally stoichiometric conditions while maintaining fuel-rich conditions overall. However, the non-homogeneous conditions of a diffusion flame lead to the production of soot and generally slow kinetics in the colder zones of combustion. The slow kinetics and soot formation require that the fluid flow rate be kept low in order to reach equilibrium conditions, thereby requiring a large combustion chamber.

Thus, an improved apparatus and method for fuel reforming is desired in order to achieve equilibrium conditions at fuel rich conditions with a reduced combustor size while maintaining stable combustion conditions.

### BRIEF DESCRIPTION OF THE DRAWINGS

FIG. 1 is a graph illustrating the relationship of equivalence ratio to the temperature of combustion.

FIG. 2 is a schematic illustration of an axially arranged two-stage combustion reformer.

FIG. 3 is a schematic illustration of another axially arranged multi-stage combustion reformer.

FIG. 4 is a schematic illustration of a radially staged combustion reformer.

FIG. 5 is a schematic illustration of a reverse flow, radially staged combustion reformer.

FIG. 6 is a schematic illustration of a multi-stage combustion reformer in a multi-combustor arrangement.

FIG. 7 is a schematic illustration of a multi-stage catalytic combustion reformer.

FIG. 8 is a schematic illustration of a multi-stage combustion reformer incorporating both gas-phase and catalytic combustion in a parallel flow arrangement.

FIG. 9 is a schematic illustration of a multi-stage combustion reformer incorporating both gas-phase and catalytic combustion in a series flow arrangement.

FIG. 10 is a schematic illustration of a gas-to-liquid reforming system including a multi-stage combustion fuel reformer.

### DETAILED DESCRIPTION OF THE INVENTION

The temperature of combustion of a fuel in air is related to the equivalence ratio of the fuel and air utilized in the process, as illustrated by representative curve 10 of FIG. 1. Equivalence ratio (φ) is defined as the ratio of the actual fuel/air ratio to the stoichiometric fuel/air ratio. At stoichiometric conditions, both the fuel and the oxygen in the air are completely consumed by the combustion. An equivalence ratio of less than 1.0 indicates lean combustion and an equivalence ratio of greater than 1.0 indicates rich combustion. A peak combustion temperature is achieved at or near stoichiometric conditions, such as in region 12 of curve 10. At the relatively rich combustion conditions utilized in prior art combustion reformers, such as in region 14 of curve 10, the temperature of combustion is significantly below that which is achieved at near-stoichiometric conditions. The kinetics of the oxidation reaction at these relatively lower temperatures are significantly slower than at the temperatures of near-stoichiometric combustion.

The present inventors have developed an improved fuel reforming process incorporating staged combustion wherein heat energy that is generated in a lean stage (for example φ=0.5-1.0) or moderately rich stage (for example φ=1.05-3.0) is used to accelerate the kinetics of a rich stage (for example φ=2-5) in order to reform fuel in less time and in a smaller space envelope than would be achieved by combusting the same combined quantity of fuel and air in a homogenous mixture. This concept may be appreciated by referring to FIG. 1, where an overall quantity of fuel and air, that otherwise would exhibit an equivalence ratio in region 14 of curve 10, is instead combusted in at least two stages, such as a lean or moderately rich stage in region 12 and a rich stage in region 16 of curve 10. By splitting the total oxygen between the lean and rich stages, the fuel can be burned in rich and lean stages to achieve the desired equivalence ratio. The present inventors have recognized and have innovatively exploited the non-linear relationship between equivalence ratio and temperature of combustion by utilizing staged combustion in order to create a warmer average combustion temperature with resulting faster kinetics of combustion than is otherwise achieved with prior art single stage combustion reforming systems.

The present invention may be embodied in any number of combustion fuel reforming devices wherein a first stage and a second stage are cooperatively associated for the transfer of heat energy from a leaner-burning stage to a richer-burning stage in order to accelerate a fuel-reforming partial oxidation reaction. A means for heat exchange between the stages is used to accelerate the partial oxidation reaction occurring in the stage having the higher of the two equivalence ratios. The means for heat exchange may include direct mixing of the combustion gases of the two stages and/or it may include a mechanism for the transfer of heat energy without the actual mixing of the gas products. The number of stages is not necessarily limited to two; however, the inventors believe that significantly improved performance when compared with the prior art is achievable with only two stages. Furthermore, one or more of the stages may include a catalytic material for supporting catalytic combustion of the fuel and oxygen. These and other aspects of the invention are illustrated in the following conceptual embodiments.

FIG. 2 illustrates a two-stage gas reforming device 20. A first stage 22 receives a first flow 24 of fuel and oxygen at a first equivalence ratio and produces a first flow of combustion gas 26. The oxygen is typically provided as pure oxygen, however, air may be used as the source of oxygen in some embodiments. A second stage 28 is disposed downstream of the first stage 22 and receives a second flow 30 of fuel and oxygen 30 for addition to the first flow of combustion gas 26 and produces a combined flow of combustion gas 32. The richer-burning stage (i.e. higher equivalence ratio) may be either the first stage 22 of the second stage 28. Optionally, a portion 34 of the combined flow of combustion gas 32 may be recycled back to the first stage 22, thereby decreasing the required size of the combustor. A further option is selectively to introduce steam into one or both of the stages 22, 28, such as through a steam injection line 18, 18′, in order to influence the H₂/CO ratio of the output of the reforming device 20 via the water-gas shift reaction. Because the conditions of combustion vary between the two stages, the affect of the steam injection may vary depending upon the location of injection. In one embodiment, a steam injection 18 may be provided into only the richer of the stages.

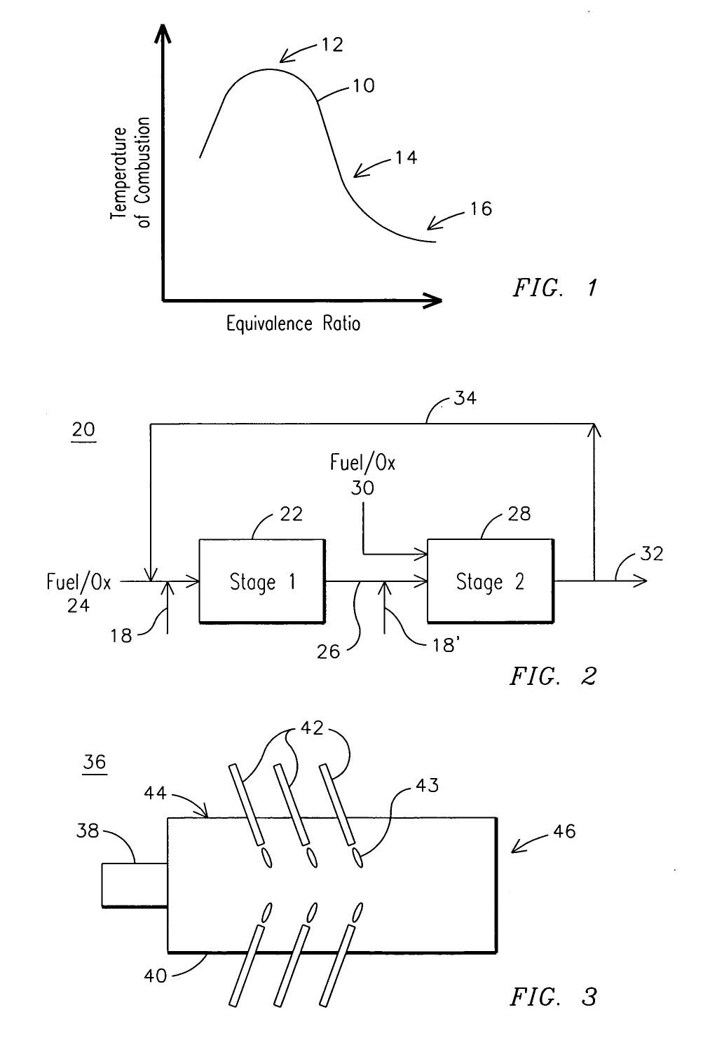

FIG. 3 illustrates another embodiment of an axially-staged combustion fuel reformer 36. A first flow 38 of fuel and oxygen 38 at a first generally richer, equivalence ratio is fed into a combustion chamber 40 where one or a plurality of second flows 42 of fuel and oxygen at a second, generally leaner equivalence ratio are injected to form hot flame zones 43 effective to increase the temperature and to accelerate the fuel conversion to equilibrium. The second flows 42 of fuel and oxygen may all have the same equivalence ratio, or there may be differences there between such as may be desired to optimize the process. One may appreciate that the equivalence ratio varies axially from a higher value at the upstream end 44 of the combustion chamber 40 to a lower value at the downstream end 46 of the combustion chamber 40.

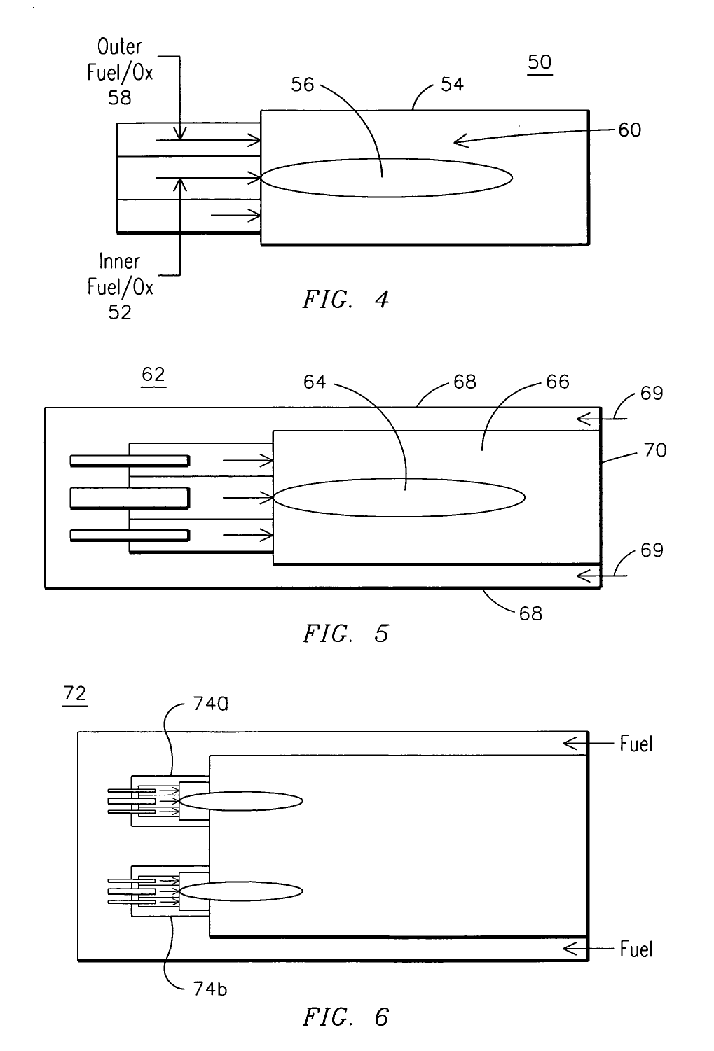

FIG. 4 illustrates an embodiment of a combustion fuel reformer 50 that includes radially staged combustion zones in contrast to the axially staged combustion zones of FIGS. 2 and 3. A first flow 52 of fuel and oxygen at a first equivalence ratio is introduced into a central region of a combustor 54 to form an inner combustion zone 56. A second flow 58 of fuel and oxygen at a second equivalence ratio is introduced around the inner combustion zone 56 to form an outer combustion zone 60. The leaner, hotter combustion zone may be either the inner combustion zone 56 or the outer combustion zone 60, although for heat-transfer and insulating purposes the former may be preferred. In such an embodiment, the inner combustion zone 56 forms a hot core effective to increase flame temperatures, thereby increasing the rate of fuel conversion in the outer combustion zone 60 and in the downstream mixed region 61 where the combined equivalence ratio is between that of the leaner and the richer zones.

The combustion fuel reformer 62 of FIG. 5 also incorporates radially disposed first and second stages 64, 66, with the further addition of a radially outermost fuel supply chamber 68 disposed about the second (outer) stage 66. Fuel 69 being delivered to one or both of the combustion stages 64, 66 travels through the fuel supply chamber 68 to effectuate a heat exchange between the hotter combustion gases and the cooler fuel. This arrangement serves both to cool the combustion chamber wall 70 and to pre-heat the fuel 69.

A multi-staged combustion fuel reformer 72 incorporating a multi-burner combustor arrangement is illustrated in schematic form in FIG. 6. A plurality of individual burners 74a, 74b, etc. are arranged in an array, such as in a circular pattern as is common for burners in power generating gas turbine engines. Each individual burner 74a, 74b contains multiple stages, such as is discussed above with respect to the combustion fuel reformers of FIGS. 4 and 5.

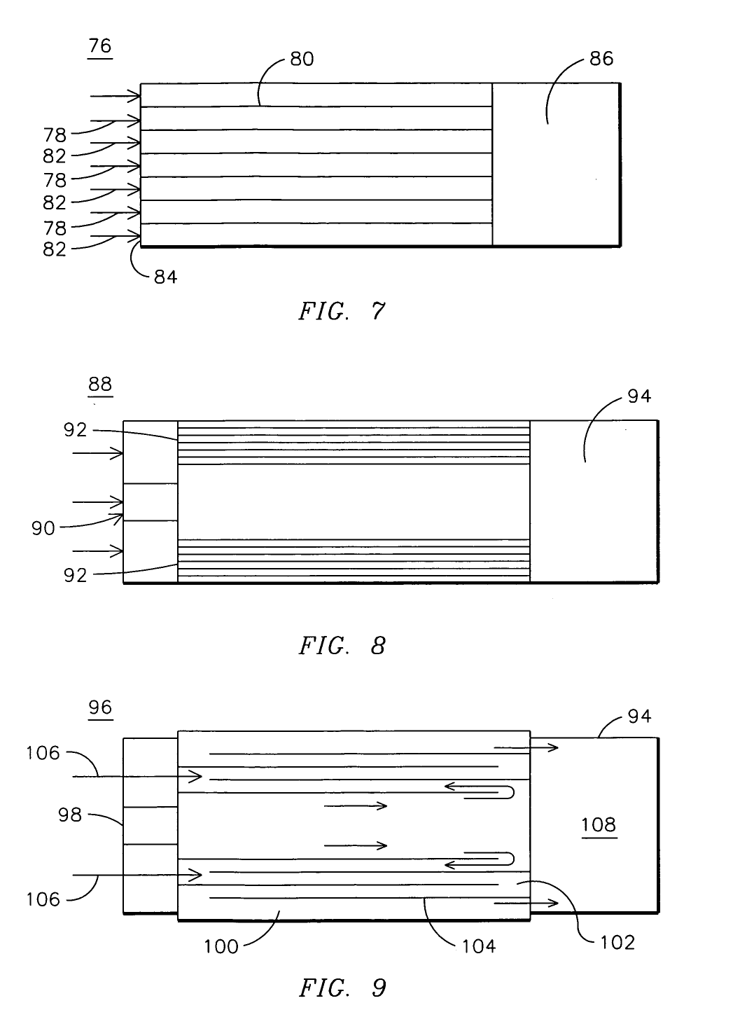

FIG. 7 illustrates a multi-stage combustion fuel reformer 76 that utilizes catalytic combustion in both of two stages. The reformer 76 includes a first plurality of channels 78 each formed at least partially of a catalytic surface 80 for receiving and combusting a first fuel/air mixture at a first equivalence ratio. The reformer 76 also includes a second plurality of channels 82 each formed at least partially of a catalytic surface 84 for receiving and combusting a second fuel/air mixture at a second equivalence ratio. The first and second channels 78, 82 are interspersed between each other so that they include common walls there between in order to facilitate heat transfer from the hofter burning (leaner) channels to the cooler burner (richer) channels, thereby accelerating the fuel reforming kinetics in the richer stage and the downstream mixed flow region 86.

FIG. 8 illustrates a multi-stage combustion gas reformer 88 that incorporates a first gas-phase combustion stage 90 and a second catalytic combustion stage 92. The gas-phase stage 90 is operated at a leaner equivalence ratio and functions to provide heat energy to the cooler-burning catalytic stage 92. In the embodiment illustrated in FIG. 8, the gas-phase stage 90 is surrounded by the catalytic stage 92, although other physical arrangements facilitating heat transfer between the two stages may be envisioned. A mixed flow region 94 is located downstream of the first and second stages for combining the flows and completing the conversion as appropriate.

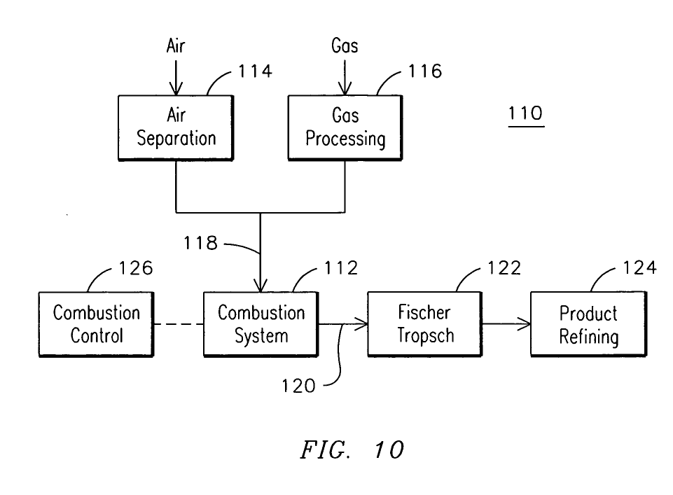

The fuel reformer 88 of FIG. 8 provides for parallel flow of the gas-phase and catalytic stages 90, 92, whereas the fuel reformer 96 of FIG. 9 provides a series flow between a gas-phase stage 98 and a catalytic stage 100. A fuel/air mixture at a first, leaner, equivalence ratio is introduced and combusted in the first stage 98. The combustion products from the first stage then enter the second, catalytic stage 100. In the embodiment of FIG. 9 the catalytic stage 100 is formed of a series of flow-reversing channels 102 each including a catalytic surface 104. Any commercially available catalytic material may be used, such as but not limited to palladium or platinum based catalysts. The equivalence ratio of the flow is increased to a desired richer value in the catalytic stage 100 by one or more fuel injectors 106. A downstream burn-out region 108 may be provided to receive the combined flow of multiple channels 102.

A gas-to-liquid fuel reforming system 110 is illustrated in FIG. 10 as including a multi-stage combustion fuel reformer 112 in accordance with the present invention. An air separation element 114 and a gas fuel processing element 116 provide a flow of gaseous fuel and oxygen 118 to the multi-stage combustion fuel reformer 112. The reformed fuel 120 exiting the reformer 112 is provided to a Fischer Tropsch element 122 for conversion of the fuel to a liquid form. A gas turbine (not shown) or other cooling device may be used to reduce the temperature of the fuel being supplied to the Fischer Tropsch element 122. A further product refining element 124 may be located downstream of the Fischer Tropsch element 122 to produce a desired final fuel product.

The above-described fuel reforming devices may operate as a premixed fuel-air system. When operating near flame extinction limits (rich or lean), such systems are subject to combustion-driven instabilities and flame-acoustics interactions that can grow and lead to flame extinction. Such combustion driven instabilities may be controlled by a combustion control feature 126 that may include, for example, passive controls such as fuel modulation, varying fuel splits, secondary fuel injection, and/or inlet swirl, in various axially staged mixture streams. Furthermore, the combustion control 126 may include active dynamics control of combustion instabilities to suppress combustion noise.

While the preferred embodiments of the present invention have been shown and described herein, it will be obvious that such embodiments are provided by way of example only. Numerous variations, changes and substitutions will occur to those of skill in the art without departing from the invention herein.

1. A combustion fuel reformer comprising:
a first stage for combusting fuel and oxygen at a first equivalence ratio;
a second stage for combusting fuel and oxygen at a second equivalence ratio different than the first equivalence ratio;
the first and second stages being cooperatively associated for the transfer of heat energy from a leaner-burning one of the stages to a richer-burning one of the stages to accelerate a fuel-reforming partial oxidation reaction.

2. The combustion fuel reformer of claim 1, wherein the second stage is disposed downstream of the first stage for combining the first stage fuel and oxygen with the second stage fuel and oxygen.

3. The combustion fuel reformer of claim 2, wherein the first stage is the richer-burning stage.

4. The combustion fuel reformer of claim 2, wherein the first stage is the leaner-burning stage.

5. The combustion fuel reformer of claim 2, further comprising a recycle flow of combustion products from downstream of the second stage to upstream of the first stage.

6. The combustion fuel reformer of claim 1, wherein the second stage comprises a plurality of fuel-oxygen injection locations axially-displaced along a direction of flow of the first stage.

7. The combustion fuel reformer of claim 1, wherein the first and second stages are radially disposed relative to each other within a combustion chamber.

8. The combustion fuel reformer of claim 1, further comprising the leaner-burning stage being annularly disposed about the richer-burning stage.

9. The combustion fuel reformer of claim 1, further comprising the richer-burning stage being annularly disposed about the leaner-burning stage.

10. The combustion fuel reformer of claim 1, further comprising a heat transfer communication between at least one of the first and second stages and a flow of fuel being delivered to the reformer.

11. The combustion fuel reformer of claim 1, further comprising:
the first stage comprising a plurality of channels comprising a catalytic surface passing the fuel and oxygen at the first equivalence ratio; and
the second stage comprising a plurality of channels comprising a catalytic surface passing the fuel and oxygen at the second equivalence ratio, the second stage channels being interspersed between respective ones of the first stage channels.

12. The combustion fuel reformer of claim 11, further comprising a combustion completion zone disposed downstream of the first and second stage channels for receiving and combining flows from the first and second stages.

13. The combustion fuel reformer of claim 1, wherein the richer-burning one of the stages comprises a channel comprising a catalytic surface disposed adjacent the leaner-burning one of the stages for heat transfer there between.

14. The combustion fuel reformer of claim 1, wherein the richer-burning one of the stages comprises a plurality of concentric channels each comprising a catalytic surface disposed about a centrally disposed leaner-burning one of the stages.

15. The combustion fuel reformer of claim 1, further comprising:
a central combustion chamber directing the fuel and oxygen at the first equivalence ratio in a forward axial direction to an end;
an annular combustion chamber surrounding the central combustion chamber and receiving flow from the end of the central combustion chamber and comprising a portion directing the flow into a reverse axial direction; and
a fuel injector injecting fuel into the annular combustion chamber.

16. The combustion fuel reformer of claim 15, wherein the annular combustion chamber comprises a catalytic surface downstream of the fuel injector.

17. The combustion fuel reformer of claim 1, further comprising a steam injection into only one of the stages.

18. The combustion fuel reformer of claim 1, further comprising a steam injection into only a richer-burning one of the stages.

19. The combustion fuel reformer of claim 1, further comprising a combustion control feature associated with at least one of the stages for controlling combustion instabilities in the reformer.

20. A gas-to-liquid fuel reforming system comprising the combustion fuel reformer of claim 1.

21. A reforming apparatus wherein a partial oxidation reaction of a fuel-oxygen mixture functions to reform the fuel, the reforming apparatus comprising:
a stage of combustion at a first equivalence ratio;
a stage of combustion at a second equivalence ratio; and
a means for heat exchange between the stages of combustion to accelerate the partial oxidation reaction occurring in a respective one of the stages of combustion having a higher of the two equivalence ratios.

22. The reforming apparatus of claim 21, wherein the means for heat exchange comprises an axial relative orientation of the stages.

23. The reforming apparatus of claim 21, wherein the means for heat exchange comprises a radial relative orientation of the stages.

24. The reforming apparatus of claim 21, wherein a first of the stages of combustion comprises a catalytic material and a second of the stages of combustion comprises a gas-phase combustor.

25. The reforming apparatus of claim 21, further comprising a means for steam injection into one of the stages.

26. The reforming apparatus of claim 21, further comprising a means for steam injection into only a richer-burning one of the stages.

27. The reforming apparatus of claim 21, further comprising a combustion control feature associated with at least one of the stages for controlling combustion instabilities in the reforming apparatus.

28. A gas-to-liquid fuel reforming system comprising the combustion fuel reformer of claim 21.
